(19) United States
(12) Patent Application Publication
(10) Pub. No.: US 2010/0266241 A1
(43) Pub. Date: Oct. 21, 2010

(54) OPTICAL TRANSMITTER AND METHOD OF MANUFACTURING THE SAME

(75) Inventor: Tetsuya HOSODA, Kanagawa (JP)

Correspondence Address: YOUNG & THOMPSON, 209 Madison Street, Suite 500, Alexandria, VA, 22314, US

(73) Assignee: NEC ELECTRONICS CORPORATION, Kawasaki-shi (JP)

(21) Appl. No.: 12/760,040

(22) Filed: Apr. 14, 2010

(30) Foreign Application Priority Data
Apr. 17, 2009 (JP) 2009-100757

(51) Int. Cl. G02B 6/30; G02B 6/36; B29D 11/00

(52) U.S. Cl. 385/49; 385/88; 216/24; 216/26

(57) ABSTRACT

Provided is an optical transmitter including, a substrate (silicon optical bench), a light emitting element, and a temperature sensing element; wherein, two recesses are formed in a surficial portion of the silicon optical bench; the light emitting element is provided inside one recess; and the temperature sensing element is provided inside the other recess.

This application is based on Japanese patent application No. 2009-100757 the content of which is incorporated hereinto by reference.

### BACKGROUND

1. Technical Field

The present invention relates to an optical transmitter and a method of manufacturing the same.

2. Related Art

In the field of optical communication technology, optical transmitter is adopted as a light source. With increase in optical communication capacity, wavelength division multiplexing has been put into practical use. In particular, in dense wavelength division multiplexing (DWDM), the optical transmitter is strongly required to ensure fine controllability and excellent stability of oscillation wavelength of light transmitted from the light source.

In order to finely control oscillation wavelength of the light source, temperature of a light emitting element which composes the light source needs be finely controlled. It is therefore critical for a temperature sensing element to accurately detect the temperature of the light emitting element, through a substrate.

For example, Japanese Laid-Open Patent Publication Nos. 2004-79989 and 2007-36046 describe optical transmitters improved in heat insulation between the inside and outside of a package. According to these publications, in the optical transmitters, bonding wires drawn out from connection terminals are not connected directly to the temperature sensing element, but electrically connected thereto while placing a substrate on an electronic cooling element in between. Heat flow into the temperature sensing elements may reportedly be suppressed, and thereby the wavelength may precisely be measured.

Temperature of walls of the package herein may vary depending on ambient temperature under which the optical transmitter is used. Heat possibly conducted from the walls may adversely affect the light emitting element and the temperature sensing element in the package. For this reason, the light emitting element may no longer be controllable in a precise manner, and thereby the oscillation wavelength of the light emitting element may fluctuate depending on ambient temperature under which the optical transmitter is used.

Japanese Laid-Open Patent Publication Nos. 2003-142767 and 2003-163408 describe the optical transmitters capable of suppressing fluctuation in the oscillation wavelength of the light emitting element. In the optical transmitters, the light emitting element and the temperature sensing element are covered with a shield component. Hideyuki Nasu (“A Small DFB-LDM for Radio on Fiber Systems”, Journal of IEICE, C, Vol. J91-C, No. 1, pp 128-135, 2008) describes an optical transmitter configured so as to place the temperature sensing element apart as possible from walls of the package and close as possible to the light emitting element, and so as to dispose another shield component between the walls of the package and the temperature sensing element, to thereby shield heat possibly conducted from the walls of the package.

### SUMMARY

With shrinkage of the optical transmitters, the light emitting element and the temperature sensing element are inevitably disposed more closer to the walls of the package. Accordingly, it is still difficult for the above-described configuration, having the shield component, to avoid influences of heat possibly conducted from the walls of the package.

In recent years, there has been developed optical transmitters having optical and electric functions integrated therein, by virtue of practice of optical waveguide technology, and passive alignment technology which enables formation of an optical coupling system on a substrate.

This sort of optical transmitters may be manufactured typically by a system based on mounting onto a silicon optical bench which uses a silicon base.

Japanese Laid-Open Patent Publication Nos. H11-295561 and 2001-242357 describe optical transmitters based on passive alignment technology. In this sort of optical transmitters, it is general to dispose the light emitting element and the temperature sensing element on the flat surface of the silicon optical bench.

As has been described in the above, the related arts described in the published documents remain to be further improved in readiness of precise wavelength control of the light emitting element.

In particular in the optical transmitters based on the silicon optical bench technology as described in Japanese Laid-Open Patent Publication Nos. H11-295561 and 2001-242357, the light emitting element and the temperature sensing element are disposed on an open flat surface on the silicon optical bench. The light emitting element and the temperature sensing element may therefore be affected by heat possibly conducted from the walls of the package. In other words, the light emitting element may internally cause thermal gradient due to heat possibly conducted from the walls of the package. In addition, also the temperature sensing element may internally cause thermal gradient. As a consequence, it has been difficult to precisely control the wavelength of the light emitting element.

Although the paragraphs in the above dealt with the wavelength division multiplexing, similar problems reside also in other general optical communication technologies.

According to the present invention, there is provided an optical transmitter which includes:

a substrate;

a light emitting element provided over the substrate; and

a temperature sensing element which measures temperature of the light emitting element, provided over the substrate.

The substrate has a recess provided in a surficial portion thereof, and the light emitting element and the temperature sensing element are provided inside the recess.

According to the present invention, there is also provided a method of manufacturing a method of manufacturing an optical transmitter which includes:

forming a mask layer over the top surface of a substrate, and forming, in the mask layer, a opening in which a part of the top surface of the substrate exposes;

removing, in the opening of the mask layer, the substrate by a predetermined depth, to thereby form a recess; and

providing, inside the recess, a light emitting element and a temperature sensing element.

By providing the light emitting element and the temperature sensing element inside the recess of the substrate, heat possibly conducted from the external environment may be shielded by the contribution of the sidewalls of the recess. Accordingly, the internal thermal gradient of the light emitting element and the temperature sensing element may be suppressed. Thereby, the temperature sensing element may accurately monitor temperature of the light emitting element, and may accurately control the temperature of the light emitting element.

According to the present invention, a configuration capable of embodying an optical transmitter which is excellent in controllability of oscillation wavelength of the light emitting element, and a method of manufacturing of the same, may be provided.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a perspective view schematically illustrating an optical transmitter according to the first embodiment of the present invention;

FIGS. 2 and 3 are sectional views schematically illustrating the optical transmitter of the first embodiment;

FIG. 4 is a sectional view schematically illustrating an optical transmitter of a second embodiment;

FIG. 5 is a sectional view schematically illustrating an optical transmitter of a third embodiment; and

FIG. 6 is a sectional view schematically illustrating an optical transmitter of a fourth embodiment.

### DETAILED DESCRIPTION

The invention will now be described herein with reference to illustrative embodiments. Those skilled in the art will recognize that many alternative embodiments can be accomplished using the teachings of the present invention and that the invention is not limited to the embodiments illustrated for explanatory purposes.

Embodiments of the present invention will be explained referring to the attached drawings. Note that all similar constituents in all drawings are given similar reference numerals or symbols, explanations of which will not always necessarily be repeated.

### First Embodiment

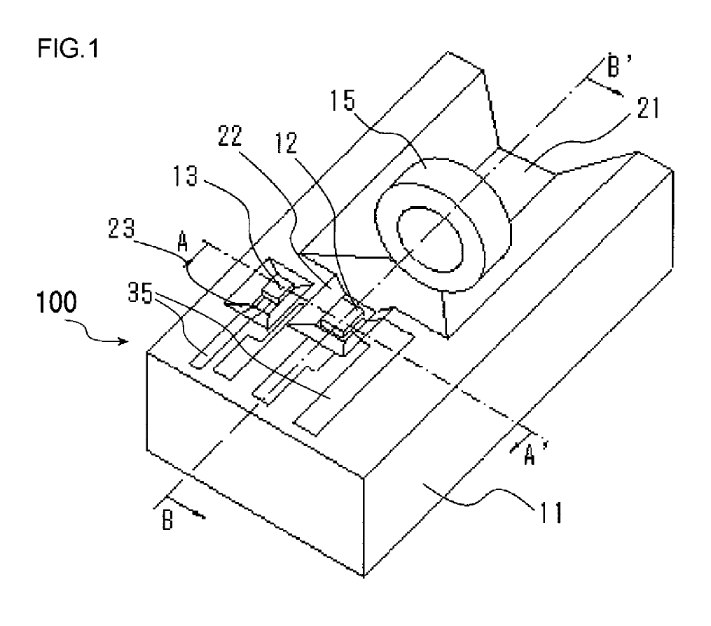

An optical transmitter of a first embodiment will be explained, referring to FIGS. 1 to 3.

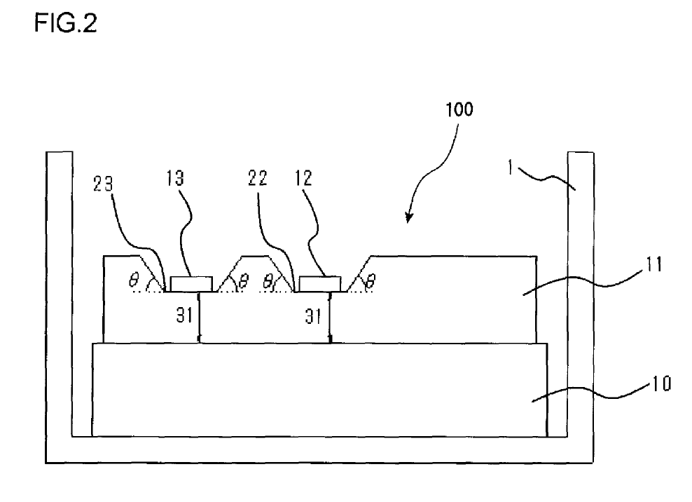

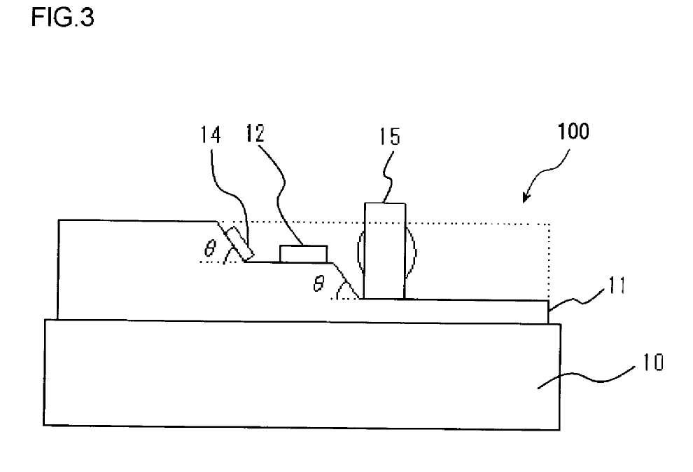

FIG. 1 is a perspective view illustrating a silicon optical bench 11 of an optical transmitter 100 of a first embodiment. FIGS. 2 and 3 are sectional views taken along lines A-A′ and B-B′ in FIG. 1, respectively. In the drawings, a part of metallized interconnects, bonding wires, metal patterns, packages and so forth are not illustrated so as to avoid complexity.

The optical transmitter 100 of the first embodiment has a substrate (silicon optical bench 11), a light emitting element 12, and a temperature sensing element 13. The silicon optical bench 11 has a recess 22 and a recess 23 formed in a surficial portion thereof. The light emitting element 12 is provided inside the recess 22, and the temperature sensing element 13 is provided inside the recess 23.

As illustrated in FIG. 1, the light emitting element 12 and the temperature sensing element 13 are disposed on the bottom portions of the recesses 22, 23, respectively. As a consequence, the recesses 22, 23 are configured so that the side faces thereof serve as walls which surround light emitting element 12 and the temperature sensing element 13, respectively.

The optical transmitter 100 further includes a package 1, a monitoring photo diode 14, a coupling lens 15 and an electronic cooling element 10 illustrated in FIG. 2 or FIG. 3. In this embodiment, a silicon substrate is used as the substrate, a semiconductor laser element is used as the light emitting element 12, and a thermistor for monitoring temperature is used as the temperature sensing element 13.

The coupling lens 15 guides light (laser light) output from the light emitting element 12 to an optical fiber (not illustrated). The coupling lens 15 is disposed inside a trench (the recess 21) which is formed in the surficial portion of the silicon optical bench 11, while being aligned with the direction of the optical axis of laser light, as illustrated in FIG. 1. The optical fiber is coupled with the light emitting element 12 while placing the coupling lens 15 in between, and allows the laser light output from the light emitting element 12 to transmit therethrough.

The electronic cooling element 10 cools the light emitting element 12 and the temperature sensing element 13 so as to regulate the temperature. The electronic cooling element 10 is mounted below the silicon optical bench 11.

In the optical transmitter 100 of this embodiment, the temperature sensing element 13 detects temperature of the silicon optical bench 11. Based on the thus-detected temperature, a control section (not illustrated) of the optical transmitter 100 controls temperature of the electronic cooling element 10, and thereby temperature of the silicon optical bench 11 is controlled. The optical transmitter 100 then controls temperature of the light emitting element 12, and thereby the oscillation wavelength of the light emitting element 12 is controlled.

Constituents and positional relations thereamong in the individual configurations of the optical transmitter 100 according to this embodiment will be detailed below.

As illustrated in FIG. 1, each of the recesses 21, 22, 23 has a bottom surface configured by a flat surface, and has side faces configured by a plurality of inclined surfaces inclined by a predetermined angle away from the flat surface. Given that (100) crystal plane exposes to the top surface of the silicon optical bench 11, the inclined surface of the recesses 21, 22, 23 will have (111) surface orientation, with an angle θ of the inclined surfaces with respect to the flat bottom uniquely given as 54.74°. The angle may be accomplished by anisotropic etching in a precise and highly reproducible manner. In this embodiment, flat surfaces with (100) surface orientation are formed at the bottoms of the recesses 21, 22, 23, by anisotropic etching took place over a predetermined length of time. The area of the bottom and the depth of the individual recesses 21, 22, 23 may uniquely be determined, depending on the area of opening of the mask and etching time in the anisotropic etching. The depth of each recess is defined by a distance, in the direction of perpendicular line, between the surface of the silicon optical bench 11, which is assumed as a reference surface, and the bottom surface of the recess.

The recess 21 and the recess 22 are formed side-by-side in the direction of optical axis, as illustrated in FIG. 1. In this configuration, the internal space of the recess 22 and the internal space of the recess 21 are formed side-by-side in the direction of optical axis. More specifically, there is no obstruction which possibly inhibits rectilinear propagation of laser light, such as sidewall in the recess 22, formed over a path which extends from the light emitting element 12 to the coupling lens 15. The bottoms of the recess 21 and the recess 22 are formed in a seamless manner in the direction of optical axis. The light emitting element 12 is mounted on the bottom of the recess 22. Position of the coupling lens 15 is adjusted so that the optical axis of the laser light output from the light emitting element 12 coincides with the center of the coupling lens 15. The area of opened top of the recess 21 is larger than that of the recess 22. The depth of the recess 21 is larger than that of the recess 22.

On the other hand, the recess 22 and the recess 23 are formed, apart from each other in a direction orthogonal to the optical axis, as illustrated in FIG. 1. In this configuration, the light emitting element 12 and the temperature sensing element 13, respectively provided on the bottoms of the recesses 22, 23, are disposed so as to overlap with each other, when viewed in the above-described orthogonal direction. The depth of the recess 22 is equal to that of the recess 23.

As illustrated in FIG. 2, the silicon optical bench 11 has the same thickness 31 at a position where the light emitting element 12 is disposed, and at a position where the temperature sensing element 13 is disposed. The thickness 31 represents the distance between the bottom of either of the recesses 22, 23 to the back surface of the silicon optical bench 11, in the direction of perpendicular line which stands on the substrate.

On the other hand, as illustrated in FIG. 3, the silicon optical bench 11 is configured to have the thickness 31 at the position where the light emitting element 12 is disposed, larger than that of the position where the coupling lens 15 is disposed. Height of disposition of the coupling lens 15 is thus adjusted so as to make the center thereof agree with the optical axis.

The coupling lens 15 has a cylindrical portion, and is directly fixed inside the recess 21, so that the cylindrical portion is brought into linear contact with each of the inclined surfaces and the bottom surface of the recess 21 (trench). In this way, the coupling lens 15 is mounted by passive mounting on the top of the silicon optical bench 11.

Metallized interconnects 35 illustrated in FIG. 1 are provided over regions extending from the bottom surfaces and inclined surfaces of the recesses 22, 23 towards the top surface of the silicon optical bench 11. Electrical connection between the top surface of the silicon optical bench 11 and the bottoms of the recesses 22, 23 is thus established. The light emitting element 12 and the temperature sensing element 13 are disposed on portions of the metallized interconnects 35 formed on the bottoms of the recesses 22, 23.

Next, a method of manufacturing the optical transmitter 100 of the first embodiment will be explained, referring to FIG. 1 to FIG. 3.

The method of manufacturing the optical transmitter 100 of this embodiment includes the steps below:

a step of forming a mask layer over the top surface of a substrate (silicon substrate), and forming, in the mask layer, openings (first openings) in which a part of the top surface of the substrate exposes;

a step of removing (anisotropically etching), in the openings of the mask layer, the substrate by a predetermined depth, to thereby form the recesses 22, 23; and

a step of providing, inside the recesses 22, 23, the light emitting element and the temperature sensing element. In the method herein, a plurality of first openings are formed.

The method of manufacturing the optical transmitter 100 will be detailed below, in a step-wise manner.

First, a silicon substrate having (100) surface exposed to the top surface, is obtained. Next, over the top surface thereof, a silicon oxide film is formed typically by CVD (Chemical Vapor Deposition), and a resist film is formed on the silicon oxide film. The resist film is patterned by a lithographic process, and the silicon oxide film is then patterned by dry etching through the resist film, to thereby form a plurality of openings (two first openings, and one second opening, not illustrated) in which a part of the top surface of the substrate exposes. The resist film is removed, and the silicon substrate is then immersed into a KOH (potassium hydroxide) solution over a predetermined duration of time. Portions of the silicon substrate exposed in the individual openings are anisotropically etched by the wet process, based on dependence of crystal orientation. As a consequence, the plurality of recesses are formed by a single process. More specifically, the silicon substrate is anisotropically etched in the first openings to a predetermined depth D1 to thereby form the recesses (recess 22, recess 23) having the walls with (111) surface orientation and having the bottoms with (000) surface orientation, and the silicon substrate is anisotropically etched in the second opening to a predetermined depth D2 to thereby form a trench (recess 21) having the walls with (111) surface orientation, and having the bottom with (000) surface orientation.

In this way, the recesses 21, 22, 23 having the inclined surfaces with (111) surface orientation, uniquely inclined by 54.74° away from the bottom with (100) surface orientation, may be formed at the same time.

In this method, the area of the bottom and the depth of the individual recesses 21, 22, 23 may uniquely be determined, depending on the area of opening of the mask and etching time in the anisotropic etching.

For example, the etching may be terminated at the same time in the individual recesses 21, 22, 23, by appropriately adjusting the area of the individual openings formed in the mask for anisotropic etching.

More specifically, the recesses 22 and 23 having a bottom area of 1.0 mm×1.0 mm and a depth of 1.0 mm, illustrated in FIG. 2 and FIG. 3, may be formed through openings of the mask, which correspond to the recesses 22 and 23, having an area of opening of 2.414 mm×2.414 mm. By setting the same dimension to the openings, the silicon optical bench 11 may be designed to have the same thickness 31 at the position where the light emitting element 12 is disposed, and at the position where the temperature sensing element 13 is disposed.

On the other hand, the recess 21 having a bottom area of 1.0 mm×0.43 mm and a depth of 1.7 mm may be formed through an opening of the mask, which corresponds to the recess 21, having an area of opening of 2.202 mm×2.834 mm. By setting the dimensions of the openings corresponding to the recesses 21 and 22, the levels of height of the portions of the silicon substrate, where the light emitting element 12 and the coupling lens 15 are mounted, are controlled, and thereby the height of the light emitting element 12 and the height of the coupling lens 15 are adjusted. In this step, the dimension of the opening corresponded to the recess 21 is larger than the of the opening corresponded to the recess 22.

One of the first openings corresponded to the recess 22, and the second opening corresponded to the recess 21 are formed side-by-side in the direction of the optical axis. More specifically, one of the first openings and the second opening are formed to give a single seamless opening. On the other hand, the openings (two first openings) of the mask, corresponded to the recesses 22 and 23, are formed so as to overlap with each other, when viewed in the direction orthogonal to the optical axis. In other words, the individual first openings are formed apart from each other in the orthogonal direction, when viewed in the direction of perpendicular line which stands on the substrate.

As a result of the steps up to now, the silicon optical bench 11 having a plurality of recesses 21, 22, 23 formed in the silicon substrate is manufactured (FIG. 1).

Next, an electrode pattern is formed on the silicon optical bench 11, and a solder layer for mounting the elements, typically composed of AuSn, is formed thereon. Also an alignment pattern is formed at the same time with the electrode pattern. At this point of time, the recess 22 and the recess 23 have the electrode pattern and the AuSn layer formed on the individual inclined surfaces and bottom surfaces thereof. Next, the light emitting element 12 is mounted on the AuSn layer on the bottom of the recess 22 by passive mounting, and the temperature sensing element 13 is mounted on the AuSn layer on the bottom of the recess 23 again by passive mounting.

Next, a resin is coated on the bottom surface of the recess 21, corresponding to a position of mounting of the coupling lens 15. The resin adoptable herein may be a UV-curable resin. Amount of resin is adjusted to be constant, using a dispenser. The coupling lens 15 is then placed on the top of the coated resin layer, so as to be brought into contact with both inclined surfaces. The resin is then cured by UV irradiation, so as to fix the position of the coupling lens 15. The product is then subjected to post-baking, so as to thoroughly cure the resin, to thereby further improve the adhesive strength. In this way, the cylindrical portion of the coupling lens 15 is brought into linear contact with the inclined surfaces of the recess 21. The coupling lens 15 herein is disposed so as to make the center thereof agree with the optical axis of laser light output from the light emitting element 12.

Also an inductor (not illustrated), a resistor element (not illustrated) and so forth are similarly disposed over the silicon optical bench 11. The silicon optical bench 11 having the individual elements disposed thereon is then mounted on the electronic cooling element 10. The electronic cooling element 10 is mounted in the package 1.

The package 1 is then nitrogen-sealed. In this process, a fiber is assembled if the optical transmitter 100 is given in a form of pig tail module, whereas a receptacle is assembled if given in a form of optical sub-assembly (OSA) module.

The optical transmitter 100 of the first embodiment may be obtained, as described in the above.

Operations and effects of this embodiment will be explained below.

According to the optical transmitter 100 of this embodiment, heat possibly conducted from the wall surface of the package 1 may be shielded, by disposing the light emitting element 12 and the temperature sensing element 13 inside the recesses 22 and 23 of the silicon optical bench 11. More specifically, by providing walls composed of the individual inclined surfaces of the recesses 22 and 23 around the light emitting element 12 and the temperature sensing element 13, heat possibly conducted from an external environment may be shielded, wherein the external environment may be assumed in a certain device having the optical transmitter 100 incorporated therein, in which some other component in the device produces heat.

Accordingly, thermal gradient inside the light emitting element 12 and the temperature sensing element 13 may be suppressed, and thereby the temperature sensing element 13 may accurately monitor the temperature of the light emitting element 12. The electronic cooling element 10 may therefore control the temperature of the light emitting element 12 in an accurate manner, so that the oscillation wavelength of the light emitting element 12 may precisely be controlled.

In addition, by setting the same distance from the electronic cooling element 10 (thickness 31 of the silicon optical bench 11) to the light emitting element 12 and to the temperature sensing element 13, thermal resistance of the silicon optical bench 11 at these elements may be equalized. Accordingly, the temperature sensing element 13 may accurately measure the temperature of the light emitting element 12, and thereby control the oscillation wavelength of the light emitting element 12 in a more precise manner.

As can be understood from the above, the optical transmitter 100 of this embodiment may be used over a wide range of temperature environment, under which the oscillation wavelength of the light emitting element may stably be kept without being affected by the environmental temperature.

Since the first embodiment successfully shields heat possibly conducted from the walls of the package, without using any extra component, so that the productivity may be improved, and the optical transmitter 100 may be manufactured at a low cost.

Given now that (100) crystal plane exposes to the top surface of the silicon optical bench 11 as illustrated in FIGS. 2 and 3, the inclined surface of the recesses 21, 22, 23 will have (111) surface orientation, with an angle θ of the inclined surfaces with respect to the flat bottom uniquely given as 54.74°. The angle may be accomplished by anisotropic etching in a precise and highly reproducible manner. In this embodiment, flat surfaces with (100) surface orientation are formed at the bottoms of the recesses 21, 22, 23, by anisotropic etching took place over a predetermined length of time. The area of the bottom and the depth of the individual recesses 21, 22, 23 may uniquely be determined, depending on the area of opening of the mask and etching time in the anisotropic etching. Accordingly, the recesses in this embodiment may be formed in a highly precise and controllable manner.

The predetermined depth D2 may be made larger than the predetermined depth D1, by setting the dimension of the second opening (corresponded to the recess 21) larger than that of the first opening (corresponded to the recess 22). The height of the light emitting element 12 and the coupling lens 15 may therefore be adjustable. The inclined surfaces of the recess 21 act as positioning surfaces of the coupling lens 15. In other words, the coupling lens 15 may be immobilized, when the cylindrical portion of the coupling lens 15 is fixed between the inclined surfaces of the trench (recess 21) with the aid of resin or the like. Accordingly, the coupling lens 15, the light emitting element 12 and the optical fiber may precisely be aligned.

In this embodiment, the recess is formed so as to have the tapered cross-section, that is, to have the bottom surface with (100) surface orientation, and the inclined surfaces with (111) surface orientation inclined from the bottom at an angle θ of 54.74°. With this structure, the metallized interconnects 35 may be formed so as to extend from the top surface of the silicon optical bench 11 towards the side faces and the bottom of the recesses. Therefore the metallized interconnects 35 may be suppressed from being broken, and thereby the optical transmitter 100 excellent in the conductivity may be manufactured.

In the wet etching process in this embodiment, the height of the coupling lens 15 and the light emitting element 12 may be controllable, and positions of the coupling lens 15 and the light emitting element 12 in the direction of optical axis may be controllable, by appropriately adjusting the dimension and position of formation of the openings. By virtue of the mode and the method of mounting of the coupling lens, the silicon optical bench 11 may be ensured to have desirable characteristics, in particular an optical coupling efficiency which represents a ratio of light output from the light emitting element and light input to the optical fiber.

In addition, by positioning the temperature sensing element 13 and the light emitting element 12 so as to be equally distant from the side face of the package 1 in the direction of optical axis, the elements may equally be affected by heat possibly conducted from the side face of the package 1. Accordingly, the temperature sensing element 13 may accurately measure the temperature of the light emitting element 12.

In addition, by mounting the monitoring photo diode 14 on the inclined surface of the recess 22, characteristics of the light emitting element 12 may be suppressed from being adversely affected by a monitor light which is output from the light emitting element 12, reflected on the photodiode 14, and returned again into the light emitting element 12. This configuration allows adoption, as the light emitting element 12, of a surface-emitting semiconductor laser element which has a low reflectivity on the end face thereof, and may therefore be affected by the light reflected from the monitoring photo diode 14 to a non-negligible degree.

Effects of this embodiment will further be explained, in comparison with the prior art.

The optical transmitters described in Japanese Laid-Open Patent Publication Nos. 2003-142767 and 2003-163408 adopt the shield components so as to accomplish heat shielding with respect to the walls of the package. Use of the extra shield components has, however, made the assembly difficult and has increased the cost. Another problem has been such that thermal capacity of the components to be controlled by the electronic cooling element increases, and thereby the power consumption of the electronic cooling element increases.

In contrast, the optical transmitter 100 of this embodiment may successfully accomplish heat shielding as described in the above, by virtue of the configuration having the light emitting element 12 and the temperature sensing element 13 provided inside the recesses 22 and 23, without using any extra shield components. Accordingly, the optical transmitter 100 may be simplified in the configuration, improved in the readiness of assembly, and decreased in the cost. Accordingly, the productivity of the optical transmitter 100 may be improved. Since the configuration needs no extra shield component for the components to be thermally controlled by the electronic cooling element 10, so that the heat capacity of the components to be controlled by the electronic cooling element 10 may be suppressed from increasing, and thereby the power consumption of the electronic cooling element 10 may be suppressed to a low level.

### Second Embodiment

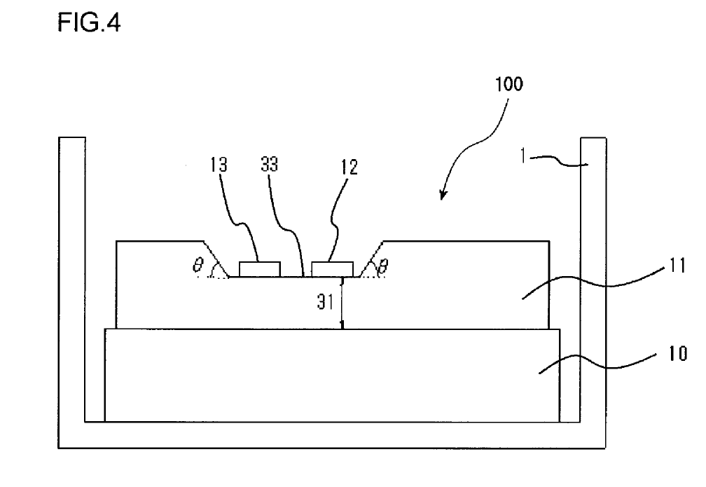

An optical transmitter of a second embodiment will be explained below, referring to FIG. 4.

FIG. 4 is a schematic sectional view of the optical transmitter 100 of the second embodiment.

The second embodiment is different from the first embodiment, in that the light emitting element 12 and the temperature sensing element 13 are mounted inside a same recess 33.

The recess 33 is formed at the same time with the recess 21. In this process, the depth of the recess 33 and the depth of the recess 21 are adjusted so as to optimize the height of the light emitting element 12 and the coupling lens 15.

The recess 33 has a depth and a bottom surface area sufficient for mounting the light emitting element 12 and the temperature sensing element 13. This level of depth and bottom surface area of the recess 33 are determined, based on the area of opening of the mask in the wet etching process, as described in the above.

Since the light emitting element 12 and the temperature sensing element 13 in the second embodiment are provided on the same bottom of the recess 33, so that the light emitting element 12 and the temperature sensing element 13 may be brought into close vicinity, and thereby the distance of these elements from the side face of the package, in the direction normal to the direction of optical axis, may be reduced. By virtue of this configuration, the temperature sensing element 13 and the light emitting element 12 may equally be affected by heat possibly conducted from the side face of the package 1, so that the temperature sensing element 13 may more accurately measure temperature of the light emitting element 12.

Also the effects of the first embodiment may be obtainable by this embodiment.

In the second embodiment, the effect of shielding heat possibly conducted from the walls of the package 1 may be reduced, if the recess 33 has a large area of the flat bottom. For this reason, the recess 33 may preferably be deepened as compared with the recesses 22 and 23 in the first embodiment. By deepening the recess 33, the effect of shielding heat may be ensured to a desirable level.

### Third Embodiment

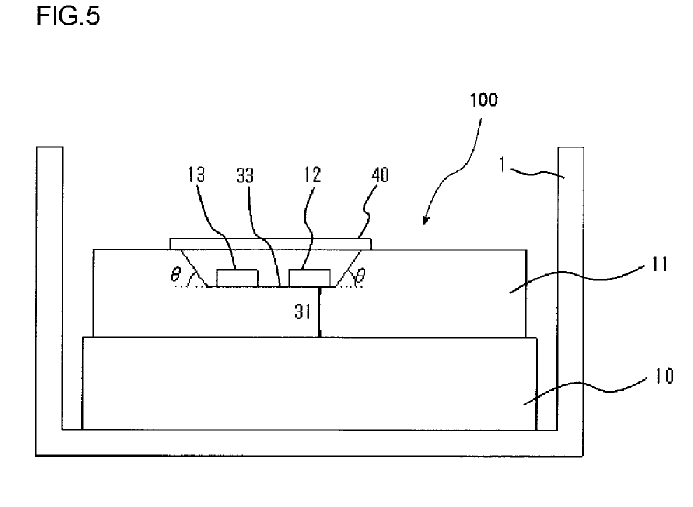

An optical transmitter of a third embodiment will be explained below, referring to FIG. 5.

FIG. 5 is a schematic sectional view of the optical transmitter 100 of the third embodiment.

The third embodiment is different from the second embodiment, in that a cover substrate 40 is additionally provided so as to cover the opening of the recess 33. The cover substrate 40 adoptable herein is a silicon substrate, for example. The cover substrate 40 and the silicon optical bench 11 are fixed with each other, typically by using a resin.

Since the effect of shielding heat, possibly conducted from the wall of the package 1, may further be enhanced by the cover substrate 40, so that the third embodiment may give an additional effect of making the temperature sensing element 13 measure the temperature of the light emitting element 12 in a more accurate manner. Also the effects of the first and second embodiments may be obtainable by this embodiment.

While the third embodiment dealt with the case where the light emitting element 12 and the temperature sensing element 13 are provided in the recess 33, the individual elements may be provided in different recesses as described in the first embodiment. In this case, the openings of the individual recesses may be covered with a single cover substrate, or with a plurality of cover substrates.

### Fourth Embodiment

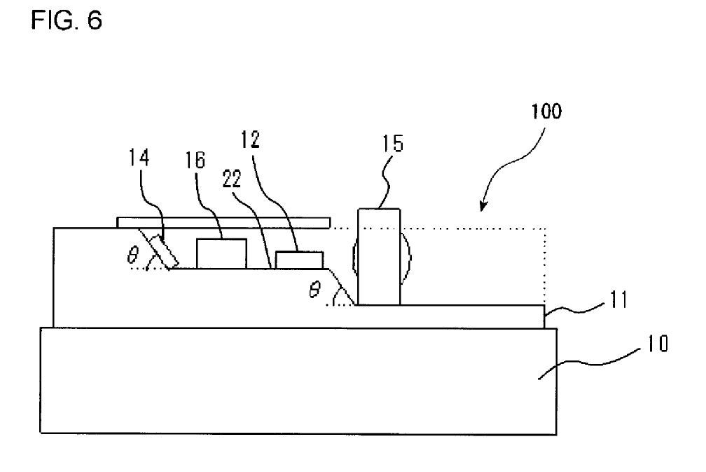

An optical transmitter of a fourth embodiment will be explained below, referring to FIG. 6.

FIG. 6 is a schematic sectional view of the optical transmitter 100 of the third embodiment.

The optical transmitter 100 of the fourth embodiment is one example of optical transmitter used at a fixed wavelength. In addition to the configuration of the first embodiment, an etalon 16 is provided inside the recess in the fourth embodiment. The etalon 16 is mounted on the optical axis of light output from the light emitting element 12 but on the side opposite to the coupling lens 15.

After disposing the light emitting element 12, the temperature sensing element 13, the monitoring photo diode 14, and the coupling lens 15 as described in the first embodiment, the etalon 16 is mounted while detecting current of the monitoring photo diode 14. The etalon 16 is mounted using a resin.

The etalon 16 herein means a narrow-band filter having a high transmissivity. The etalon 16 has excellent features such as small wavefront distortion, low insertion loss, and easy tunability of wavelength, and is used for the optical transmitter 100 used at a fixed wavelength. Transmitted light from the etalon 16 is detected by the monitoring photo diode 14, and the wavelength of the light emitting element 12 is fixed by setting an appropriate current value.

The etalon 16 is generally made of quartz, and of course the etalon 16 per se used in this embodiment has a temperature characteristic. Therefore, by shielding the etalon 16 from heat possibly conducted from the walls of the package 1 as in the fourth embodiment, accuracy in the fixation of wavelength may be improved to a considerable degree.

The embodiments of the present invention have been described referring to the attached drawings, merely as exemplary cases of the present invention, while allowing other various configurations other than those described in the above.

The recesses, which were formed by wet etching of the silicon substrate with (000) surface orientation in the above-described embodiments, may alternatively be formed typically by wet etching of a silicon substrate with (110) surface. By this process, the recesses are given to have larger depth and side walls with (111) surface. The recesses formed herein will have the side faces substantially normal to the principal surface of the substrate, and the bottom surface substantially in parallel with the principal surface of the substrate.

The cross-sectional geometry of the recesses, taken along the normal line on the substrate, are not specifically limited, while allowing various geometries including tapered geometry, square and rectangle. Also plane geometry of the recesses in the top view may be any of various geometries such as square and rectangle. Also plane geometry of the openings of the mask in the top view may be any of various geometries such as square and rectangle.

For the case where a plurality of openings are formed in the mask, the dimension of the individual openings may be identical with, or different from each other. The individual openings may be formed so as to communicate with each other, or spaced by a predetermined distance from each other, in the direction of optical axis. For an exemplary case where two openings are formed so as to communicate with each other, there is no side face of the recess formed at the common edge of the openings. In other words, the internal space of the recess (recess 22) and the internal space of the trench (recess 21) are provided so as to communicate with each other in the direction of optical axis of light.

As the etching solution, TMAH (tetramethylammonium hydroxide) for example may be adoptable, besides the above-described KOH (potassium hydroxide).

In the method of forming the recess in this embodiment, not only the above-described wet etching, but also dry etching (ion beam etching) or other various types of etching may be adoptable. In short, so long as the silicon substrate may be bored, and the walls may be formed so as to surround the light emitting element 12 and the temperature sensing element 13, various methods may be adoptable as the method of forming the recesses.

The recesses in this embodiment are not limited to the recesses 22 and 23, but may be a still larger number of recesses. The optical transmitter 100 of this embodiment may further has a thin-film resistor (not illustrated) and an inductor (not illustrated).

While the description in the above dealt with the case where the cylindrical portion of the coupling lens 15 was brought into linear contact with the inclined surfaces and the bottom surface of the recess 21 (trench), any other various mode of fixation may be adoptable without being limited to the above-described case. For example, the coupling lens 15 may directly be immobilized in the recess 21 so that the cylindrical portion is brought into linear contact therewith at least two positions. In this way, the coupling lens 15 may be mounted on the top of the silicon optical bench 11 based on passive mounting.

The optical transmitter 100 of this embodiment may be suitable for optical transmitters, typically used as light sources for dense wavelength division multiplexing systems.

It is apparent that the present invention is not limited to the above embodiments, that may be modified and changed without departing from the scope and spirit of the invention.

What is claimed is:

1. An optical transmitter comprising:
a substrate;
a light emitting element provided over said substrate; and
a temperature sensing element which measures temperature of said light emitting element, provided over said substrate,
said substrate having a recess provided in a surficial portion thereof, and
said light emitting element and said temperature sensing element being provided inside said recess.

2. The optical transmitter as claimed in claim 1,
wherein said substrate has a plurality of said recesses provided in the surficial portion thereof.

3. The optical transmitter as claimed in claim 1,
wherein said light emitting element and said temperature sensing element are provided inside the same recess.

4. The optical transmitter as claimed in claim 2,
wherein said light emitting element and said temperature sensing element are provided inside the different recesses.

5. The optical transmitter as claimed in claim 1,
wherein said recess has a bottom surface configured by a flat surface, and has side faces configured by a plurality of inclined surfaces inclined by a predetermined angle away from said flat surface.

6. The optical transmitter as claimed in claim 1, further comprising:
a trench provided in a surficial portion of said substrate in adjacent to said recess;
and a coupling lens which guides light output from said light emitting element to an optical fiber, provided to said trench.

7. The optical transmitter as claimed in claim 6,
wherein said coupling lens has a cylindrical portion,
said trench has a bottom surface configured by a flat surface, and has side faces configured by a plurality of inclined surfaces inclined by a predetermined angle away from said flat surface,
said cylindrical portion being fixed between said inclined surfaces of said trench.

8. The optical transmitter as claimed in claim 1,
wherein said substrate has the same thickness at a position where said light emitting element is disposed, and at a position where said temperature sensing element is disposed.

9. The optical transmitter as claimed in claim 1,
wherein said light emitting element and said temperature sensing element are disposed so as to overlap with each other when viewed in the direction orthogonal to the optical axis of light.

10. The optical transmitter as claimed in claim 1,
further comprising a monitoring photo diode inside said recess having said light emitting element disposed therein.

11. The optical transmitter as claimed in claim 1,
further comprising an electronic cooling element which controls temperature of said light emitting element, provided over the lower surface of said substrate.

12. The optical transmitter as claimed in claim 1,
wherein said recess is covered with a cover component, at the opening on the top surface of said substrate.

13. The optical transmitter as claimed in claim 12,
wherein said cover component is composed of the same material with said substrate.

14. The optical transmitter as claimed in claim 1, further comprising an etalon provided inside said recess having said light emitting element disposed therein.

15. The optical transmitter as claimed in claim 1,
wherein said substrate is composed of silicon.

16. The optical transmitter as claimed in claim 1,
wherein said substrate has the top surface with (000) surface orientation.

17. A method of manufacturing an optical transmitter comprising:
forming a mask layer over the top surface of a substrate, and forming, in said mask layer, an opening in which a part of the top surface of said substrate exposes;
removing, in said opening of said mask layer, said substrate by a predetermined depth, to thereby form a recess; and
providing, inside said recess, a light emitting element and a temperature sensing element.

18. The method of manufacturing an optical transmitter as claimed in claim 17,
wherein in said forming said opening, a first opening and a second opening are formed side-by-side in said mask layer;
in said forming said recess, said substrate is anisotropically etched in said first opening to a predetermined depth D1 to thereby form said recess, and said substrate is anisotropically etched in said second opening to a predetermined depth D2 to thereby form a trench,
and the method further comprising providing a coupling lens inside said trench.

19. The method of manufacturing an optical transmitter as claimed in claim 17,
wherein in said forming said opening, a plurality of said first openings are formed, to thereby form a plurality of said recesses.

20. The method of manufacturing an optical transmitter as claimed in claim 18,
wherein said predetermined depth D2 is made larger than said predetermined depth D1, by setting the dimension of said second opening larger than that of said first opening.

21. The method of manufacturing an optical transmitter as claimed in claim 18,
wherein in said forming said opening(s), said mask layer is formed over the top surface of said substrate with (000) surface orientation, and forming, side-by-side in said mask layer, said first opening(s) and said second opening in which a part of the top surface of said substrate exposes, and
in said forming said recess(es), said substrate is anisotropically etched in said first opening(s) to a predetermined depth D1 to thereby form said recess(es) having walls with (111) surface orientation and having a bottom with (000) surface orientation, and said substrate is anisotropically etched in said second opening to a predetermined depth D2 to thereby form a trench having walls with (111) surface orientation, and having a bottom with (000) surface orientation.

22. The method of manufacturing an optical transmitter as claimed in claim 17,
further providing an etalon inside said recess having said light emitting element disposed therein.

23. The method of manufacturing an optical transmitter as claimed in claim 17,
further providing a monitoring photo diode inside said recess having said light emitting element disposed therein.

24. The method of manufacturing an optical transmitter as claimed in claim 17,
wherein said recess are covered with cover component, at the opening on the top surface of said substrate.
